(19) United States
(12) Patent Application Publication
(10) Pub. No.: US 2004/0139766 A1
(43) Pub. Date: Jul. 22, 2004

(54) Systems and methods for recycling gas used in treating optical fiber

(76) Inventors: Gene K. Weeks, Duluth, GA (US); Junjun Wu, Norcross, GA (US); Ramdane Assas, Atlanta, GA (US); Kai H. Chang, Suwanee, GA (US); Siu-Ping Hong, Alpharetta, GA (US)

Correspondence Address: William R. Silverio, SUTHERLAND ASBILL & BRENNAN LLP, 999 Peachtree Street, NE, Atlanta, GA, 30309-3996, US

(21) Appl. No.: 10/346,312

(22) Filed: Jan. 17, 2003

(51) Int. Cl. C03B 37/00

(52) U.S. Cl. 65/424; 65/532

(57) ABSTRACT

Systems and methods for treating spools of fiber using recycled gas. Spools of fiber are placed in chambers which can be sealed for exposure to the treatment gas. When a chamber is closed and sealed the treatment gas is pumped into the chamber to a specified pressure temperature and pressure to react with the fiber. Upon completion of the reaction the gas is pumped from the chamber in order to facilitate the removal of the treated fiber. The gas can be evacuated with a vacuum pump and compressed to be stored in a pressure vessel for reuse. At this time the gas may be analyzed. If the concentration of a component is too low, the gas may be vented or it may be enriched so that it may be recycled; otherwise it is compressed for storage and the process is repeated.

### FIELD OF THE INVENTION

The present invention relates generally to optical fiber manufacturing, and more specifically, to systems and methods for recycling gas used to treat optical fiber.

### BACKGROUND OF THE INVENTION

Communications and data transmission systems that transmit information signals in the form of optical pulses over optical fiber are now commonplace, and optical fibers have become the physical transport medium of choice in long distance telephone and data communication networks due to their signal transmission capabilities, which greatly exceed those of mechanical conductors. Despite their advantages, however, difficulties in their manufacture must be overcome in order for lengthy, high-yield and error-free optical fiber to be produced in mass. One such manufacturing problem is economically producing optical fiber having little or no aging loss over the lifetime of the fiber.

Optical fibers typically are fabricated by heating and drawing a portion of an optical preform usually comprising a solid glass rod with a refractive glass core surrounded by a protective glass cladding having a lower refractive index than that of the core. The glass fiber then is coated with one or more layers of protective coating materials that are cured, e.g., by radiation. Conventionally, several processes exist for fabricating optical preforms, including modified chemical vapor deposition (MCVD), vapor axial deposition (VAD) and outside vapor deposition (OVD). In conventional VAD and OVD processes, layers of glass particles or “soot” are deposited on the end surface or the outside surface, respectively, of a starter rod. The deposited soot layers then are dried or dehydrated, e.g., in a chlorine or fluorine-containing atmosphere, and sintered or consolidated to form a solid preform core rod.

Once the preform core rod is formed, optical fiber is drawn directly there from or, alternatively, one or more overclad layers are formed thereon prior to drawing optical fiber there from. The overclad layers are formed on the preform core rod, e.g., by a soot deposition technique similar to that used in forming the preform core rod. Alternatively, the overclad layers are formed by collapsing a silica-based tube or sleeve around the preform core rod. Such a process typically is referred to as the Rod-In-Tube (RIT) process. See, e.g., U.S. Pat. No. 4,820,322, which is incorporated by reference herein.

The transmission characteristics of optical fiber vary based on a number of factors, including, scattering, fiber bending and absorption loss. One type of absorption loss is aging loss, including hydrogen aging loss that occurs during the lifetime of the fiber. Aging loss is a type of undesirable absorption loss that results in increased transmission losses as conventional optical fiber ages. Aging loss is caused, e.g., by the chemical reaction between hydrogen and various defects in the optical fiber during the lifetime of optical fiber. For example, chemical reactions between germanium (Ge) defects in the optical fiber and trace amounts of hydrogen present in the environment surrounding the optical fiber contribute to GeOH losses over the life of the optical fiber.

Moreover, silicon (Si) defects introduced into the optical fiber during the manufacture of the fiber typically cause SiOH and SiH losses in the fiber, which similarly result from the reaction over time between the Si defects and hydrogen present in the fiber (or cable) environment. Unfortunately, SiOH and SiH losses often are larger and occur sooner over the life of the fiber than, e.g., the GeOH losses. For example, SiOH aging losses often are up to and even greater than approximately 0.21 dB/km at 1385 nm. In fact, Si defects are believed to be responsible for many of the SiOH losses are oxygen-rich defects (Si—O—O—Si defects). Si defects become trapped in the fiber and, as the fiber ages, the Si-defects react with hydrogen atoms to form SiH molecules, which can have an absorption loss peak at 1530 nm.

Aging losses and other losses are reduced by providing improved oxygen stoichiometry conditions in fiber manufacturing environments to reduce the likelihood of generating oxygen-rich or oxygen-deficient Si defects in optical fiber preforms and optical fibers drawn there from that, over time, attract and bond with hydrogen atoms to form molecules that contribute to increased water absorption loss or other losses. More particularly, an environment is established that does not have excessive oxygen atoms, which environment reduces the number of Si—O—O—Si defects that are formed and subsequently trapped in the silica glass. Also, an environment is established that is not oxygen-deficient, which environment reduces the number of Si—Si defects formed. The improved oxygen environments are established, e.g., through adjustment of the oxygen stoichiometry, at one or more steps during the optical fiber manufacturing process.

Although improved oxygen stoichiometry conditions reduce the likelihood of Si defects materializing in the optical fiber preforms during production, it has been found that other deficit reduction steps can be performed after the optical fiber has been drawn from the optical fiber preform. For instance, it has been shown that exposing the drawn optical fiber to deuterium, an isotope of hydrogen, decreases the likelihood of Si defects in the optical fiber from reacting with hydrogen to cause hydrogen aging loss increases. Because fewer Si defects provide fewer opportunities for hydrogen molecules to chemically react therewith, the amount of hydrogen aging loss in the optical fiber is reduced. Deuterium treatment at room temperature of fiber that already has been drawn seeks to cause reactions with Si defects that were formed during the fiber manufacturing process. Si defects that already existed in the drawn fiber, and which will accelerate subsequent hydrogen aging loss if not addressed, react with the deuterium to reduce the amount of Si defects available for combining with hydrogen and thus lead to hydrogen aging loss.

Deuterium has been used to treat optical fiber by immersing optical fiber in a deuterium-rich atmosphere after the optical fiber has been manufactured, as is suggested in Published U.S. Patent Application No. 20020090183, filed Jan. 24, 2002, the entire contents of which are incorporated herein by reference. During the immersion period the deuterium diffuses into the optical fiber to create optical fiber having predetermined levels of dissolved deuterium within the doped silica material(s). This may be accomplished by placing the optical fiber in a pressure-sealed chamber with deuterium gas at a predetermined temperature and partial pressure for a prescribed period of time that is sufficiently long so as to ensure that the desired amount of deuterium is diffused and dissolved in the optical fiber. The optical fiber is exposed to the deuterium under processing conditions so as to diffuse a sufficient amount of deuterium into the optical fiber so that at a later time the deuterium enters into chemical reaction at the active fiber defect sites, thereby rendering these sites passive and resistant to subsequent chemical combination with ordinary hydrogen.

In general, because the diffusion characteristics of deuterium in silica-containing glass are similar to those of hydrogen, deuterium diffuses through microscopic distances in relatively short periods of time. When the diffusing deuterium atoms encounter reactivate Si defects such as Si-O defects or Si defects, the deuterium atoms react therewith to form SiOD or SiD, respectively, both of which have absorption losses well outside of the 700-1600 nm wavelength region used for is telecommunications. Therefore, exposing optical fibers to deuterium reduces the concentration of Si defects available for subsequent reaction with hydrogen, which, in turn, reduces the potential for and/or extent of hydrogen aging loss in the fiber under service conditions.

U.S. patent application Ser. No. 09/891,903 (hereafter, the '903 application), filed Jun. 26, 2001, and assigned to the owner of the present application, also discloses the use of deuterium to minimize hydrogen aging loss. In this treatment process, after the drawing process is complete optical fiber is exposed to a specified concentration of deuterium in nitrogen gas under pressure inside a sealed chamber. The '903 application discloses that a drawn optical fiber may be exposed to deuterium in a 0.01 atmosphere deuterium environment at room temperature for approximately 6 days. Alternatively, the '903 application suggests that the drawn fiber may be exposed to deuterium in a 0.05 atmosphere deuterium environment at room temperature for approximately 1.5 days. According to the '903 application, optical fiber that is exposed to deuterium, and whose preform was manufactured in one or more oxygen-improved environments, exhibits transmission loss (at 1385 nm) that is less than 0.33 dB/km and hydrogen aging loss which increases thereafter less than 0.04 dB/kin.

Although the prior art suggests the use of deuterium gas in treating optical fiber to minimize aging loss, prior art methods of exposing optical fiber to deuterium are expensive because the deuterium gas used to treat the fiber is expelled after treatment. Because deuterium gas is expensive, the current practice of venting the gas after it is used to treat optical fiber is uneconomical. Therefore, what is needed is a system and method for recycling deuterium gas used to treat optical fiber so that the gas can be reused in the manufacturing process.

### BRIEF SUMMARY OF THE INVENTION

In the treatment process, spools of fiber are placed in chambers which can be sealed for exposure to the treatment gas. When the chamber is closed and sealed the treatment gas is pumped into the chamber to a specified temperature and pressure to react with the fiber. Upon completion of the reaction, which is determined by treatment gas concentration, pressure, temperature and time, the gas is pumped from the chamber in order to facilitate the removal of the treated fiber. The gas can be evacuated with a vacuum pump and compressed to be stored in a pressure vessel for reuse. At this time the concentration of the gas is also measured. If the concentration level is too low, the gas may be vented or it may be enriched so that it may be recycled; otherwise it is compressed for storage.

According to one aspect of the invention there is disclosed a method of recycling gas used to treat optical fiber. The method includes the steps of placing optical fiber in a sealed chamber, exposing the optical fiber within the sealed chamber to a treatment gas supplied by a storage tank, evacuating the treatment gas from the sealed chamber, and storing the treatment gas in the storage tank for exposure to a subsequent optical fiber.

According to one aspect of the invention, the step of storing the treatment gas includes the step of storing the treatment gas at high pressure in the storage tank. According to another aspect of the invention, the treatment gas includes deuterium. According to yet another aspect of the invention, the method also includes the steps of removing the optical fiber from the sealed chamber and placing the subsequent optical fiber in the sealed chamber.

The method can further include the step of evacuating air in the sealed chamber after the subsequent optical fiber is placed in the sealed chamber. The sealed chamber containing the subsequent fiber may also be filled with the treatment gas. According to another aspect of the invention, the method can include the step of adding fresh gas to the treatment gas prior to the step of filling the sealed chamber containing the subsequent optical fiber with the treatment gas.

According to another embodiment of the invention, there is disclosed a method of treating optical fiber using treatment gas. The method includes the steps of exposing a first optical fiber to treatment gas, storing the treatment gas, and exposing a subsequent optical fiber to the stored treatment gas.

According to one aspect of the invention, the method also includes the step of compressing the treatment gas prior to storing the treatment gas. According to another aspect of the invention, the method includes the step of placing the first optical fiber and the subsequent optical fiber in a fiber treatment chamber prior to exposing the first optical fiber and the subsequent optical fiber to the treatment gas. According to yet another aspect of the invention, the method includes the additional step of pumping down the fiber treatment chamber to remove the treatment gas.

The method may also include the step of analyzing the treatment gas prior to it being exposed to the subsequent optical fiber. Furthermore, the method may include the step of supplementing the treatment gas with fresh treatment gas to maintain desired concentration levels of the treatment gas, prior to the step of exposing a subsequent optical fiber to the treatment gas. Moreover, the method can include repeating the steps of storing the treatment gas and exposing a subsequent optical fiber to the stored treatment gas.

According to yet another embodiment of the present invention, there is disclosed a system for treating optical fiber using treatment gas. The system includes a fiber treatment chamber, into which optical fiber is placed and releasably sealed, where the fiber treatment chamber is operable to receive treatment gas to which the optical fiber placed therein is exposed. The system also includes a storage tank, operable to store the treatment gas subsequent to it being exposed to the optical fiber, where the storage tank is further operable to supply the stored treatment gas to the fiber treatment chamber for later exposure to additional optical fiber.

According to one aspect of the invention, the system also includes at least one compressor, where the at least one compressor is operable to draw the treatment gas from the fiber treatment chamber and supply the treatment gas to the storage tank. According to another aspect of the invention, the system may also include at least one pump operable to draw the treatment gas from the fiber treatment chamber subsequent to it being exposed to the optical fiber. The system can also include at least one gas analyzer to analyze the treatment gas prior to its later exposure to additional optical fiber.

According to yet another aspect of the invention, the system may further include a process controller in communication with the at least one gas analyzer, where the process controller is operable to adjust the quantity of the stored treatment gas supplied to the fiber treatment chamber for exposure to additional optical fiber. Additionally, the process controller may be operable to adjust an input supply of fresh treatment gas supplied, with the stored treatment gas, to the fiber treatment chamber for exposure to additional optical fiber.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 shows a system for treating optical fiber using recycled gas, according to one embodiment of the present invention.

FIGS. 2A, 2B, 2C and 2D show a block diagram flow chart illustrating a method for treating optical fiber using recycled gas, according to one embodiment of the present invention.

### DETAILED DESCRIPTION OF THE INVENTION

The present inventions now will be described more fully hereinafter with reference to the accompanying drawings, in which some, but not all embodiments of the invention are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

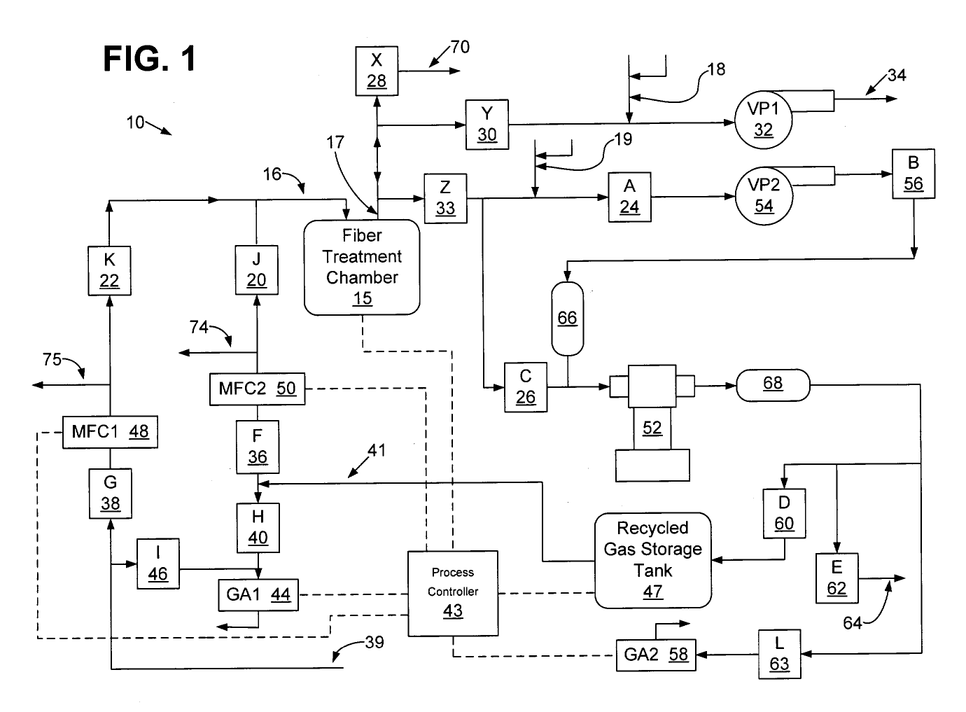

FIG. 1 shows a system 10 for treating optical fiber using treatment gas that is recyclable by the system 10 so that the gas may be used multiple times in the treatment of optical fiber. According to a preferred embodiment of the present invention, the system 10 utilizes a 3-5% deuterium-in-nitrogen gas mixture, although it will be appreciated by those of ordinary skill in the art that the system 10 may be utilized to implement optical fiber treatment using virtually any type of recycled fiber optic treatment gas. To expose optical fiber to treatment gas the system 10 includes a fiber treatment chamber 15 in which optical fiber may be placed and sealed. The fiber treatment chamber 15 is preferably operable to seal optical fiber so that it may be exposed to high temperature, high pressurized treatment gas. According to one aspect of the invention, the system 10 may also be implemented using several fiber treatment chambers (not illustrated) in order to treat separate lengths of optical fiber simultaneously. As explained in greater detail below, the system 10 also comprises a plurality of valves, pumps, analyzers, controls and interconnecting pipelines to effect the treatment of optical fiber using recycled gas.

During a treatment sequence using the system 10, optical fiber is placed in the fiber treatment chamber 15 and the chamber 15 is sealed by a system operator through manual or automatic controls. After the optical fiber is placed in the chamber 15, the air and/or residual gas (e.g., from prior treatments) within the chamber 15 is removed. This is accomplished by closing valves J 20, K 22, Z 33 and X 28, and opening valve Y 30, after which Vacuum Pump 1 (VP1) 32 expels the air within the chamber 15 through the chamber's output pipeline 17 and out a vent 34. It will be appreciated that each of the valves J 20, K 22, A 24, C 26, X 28, Y 30, Z 33, F 36, G 38, H 40, 146, B 56, D 60, E 62, L 63 shown in FIG. 1 are conventional valves well known to those of ordinary skill in the art for permitting and preventing pressurized and non-pressurized air and gas from flowing there through. Likewise, VP1 32 and Vacuum Pump 2 (VP2) 54 are conventional pumps well known to those of ordinary skill in the art for expelling air and gas from, and for forcing air and gas into, pressurized and/or non-pressurized chambers. Where the system 10 is implemented using several fiber treatment chambers, air and/or residual gas within the additional fiber treatment chambers should also be removed after optical fiber is placed and sealed therein. As such, input line 18 represents one or more output lines, similar to output line 17 with valve Y 30, from additional fiber treatment chambers. Therefore, in addition to expelling air from the fiber treatment chamber 15 shown in FIG. 1, when valves J 20, K 22, X 28 and Z 33 are closed and valve Y 30 is open, VP 1 32 will expel air from within one or more of the fiber treatment chambers through pipeline 18 and/or pipeline 17 and out the vent 34.

According to a preferred embodiment, the fiber treatment chamber 15 is pumped down to a near absolute vacuum after optical fiber is placed therein. Pumping the fiber treatment chamber 15 down to near absolute vacuum reduces the amount of contaminants in the chamber 15 before the chamber 15 receives treatment gas. Once the chamber 15 is at near an absolute vacuum achievable by the VP1 32, such as a 28″ Hg vacuum, valve Y 30 is closed. To fill the chamber 15 with treatment gas, valves F 36, G 38, J 20, and K 22 are opened. Valves J 20 and K 22 control the supply of new and/or recycled treatment gas to the chamber 15 in combination with gas analyzers GA1 44, process controller 43, and mass flow controller valves MFC1 48 and MFC2 50. As will be described in detail below, new treatment gas from a fresh gas supply 39 and/or recycled treatment gas stored in a recycled gas storage tank 47, is used to supply the fiber treatment chamber 15 with treatment gas. The volume of fresh gas used to supplement recycled gas to fill the treatment chamber 15 is controlled by the process controller 43.

It will be appreciated that upon the initial use of the system 10, and prior to the first treatment of optical fiber using fresh, unrecycled treatment gas, the recycled gas storage tank 47 is empty. Therefore, the fiber treatment chamber 15 must be filled with new treatment gas. Fresh gas supply 39 represents a supply line of new treatment gas used to fill the fiber treatment chamber 15. According to one aspect of the invention, the gas supply 39 is used to initially fill the fiber treatment chamber 15 with the requisite amount of gas, such as a 3-5% deuterium-in-nitrogen gas mixture, at a predetermined temperature and pressure. According to another aspect of the invention, the gas supply 39 is also used to supplement recycled gas used by the system 10 as the recycled gas is depleted or falls below desired concentration parameters.

To adequately fill the fiber treatment chamber 15 with the appropriate volume and concentration levels of treatment gas, the process controller relies on gas concentration measurements provided by GA1 44. GA1 44 is operable to receive a sample of gas from the fresh gas supply 39 and/or the recycled gas stream 41 provided from the recycled gas storage tank 47. Valves H 40 and 146 may be opened or closed one at a time to allow a sample gas from either fresh gas stream 39 or recycled gas stream 41 to be analyzed by a gas analyzer GA1 44. GA1 44 analyzes a sample of gas provided from recycled gas stream 41 to determine if the sample contains the appropriate mixture of gas suitable to treat optical fiber. GA1 44 then communicates the results of its measurement to the process controller 43. GA1 44 may also analyze a sample of gas provided by the fresh gas supply 39 and communicate the results to the process controller 43.

The process controller also receives pressure information from a pressure transmitter (not illustrated) located within the recycled gas storage tank 47. Accordingly, when the recycled gas storage tank 47 pressure is above a predetermined minimum tank pressure, e.g., 25 psig, the process controller can determine if gas is available from the tank 47 for use in supplying the fiber treatment chamber 15.

The process controller 43 compares the gas analysis results provided by GA1 44, and the pressure of gas within the recycled gas storage tank 47, to preprogrammed treatment gas concentration and pressure values to determine the amount of recycled and/or fresh gas required to fill the treatment chamber 15. The process controller 43 may determine that the treatment chamber should be filled entirely with recycled gas stored by the recycled gas storage tank 47, filled entirely with fresh gas provided by the fresh gas supply 39, or filled with a mixture of fresh and recycled gas. It is preferred that the process controller 43 be programmed to utilize the maximum amount of recycled gas to meet minimum treatment gas concentration levels so as to minimize the amount, and thus cost, of fresh treatment gas consumed by the system 10.

To effect control of the volume of gas provided by the fresh gas supply 39 and recycled storage tank 47, the process controller 43 is in electrical communication with MFC1 48 and MFC2 50. MFC1 48 and MFC2 50 are mass flow controller valves that control the gas flow proportions from the fresh gas supply 39 and recycled storage tank 47, respectively, and thus together operate to control the concentration of the gas, such as deuterium (D2) concentration, provided to the fiber treatment chamber 15. MFC1 48 and MFC2 50 are operable to deliver a closely regulated output of gas and are compatible with the gases, temperatures and pressures which they are subjected to throughout the range of operation. Valves J 20 and K 22 are instructed by the process controller to close, thereby stopping the supply of treatment gas after the fiber treatment chamber 15 has sufficient pressure to treat the optical fiber therein, as is measured by a pressure transmitter (not illustrated) within the fiber treatment chamber 15 and communicated to the process controller 43.

According to one aspect of the invention, the process controller uses preprogrammed D2 concentration values and information received from GA1 44 and the pressure transmitter within the recycled gas storage tank 47 to fill the fiber treatment chamber 15 with D2 treatment gas. The process controller is operable to execute three gas flow options:

(1) If the analysis of the D2 gas concentration by GA1 44 is within process specifications (e.g., GA1 determines the treatment gas to be a 3-5% deuterium-in-nitrogen mixture) and a sufficient volume of gas is in the recycled gas storage tank 47 as determined by the pressure transmitter in the tank 47, valves F 36 and J 20 are opened and valve K 22 is closed, thus filling fiber treatment chamber 15 with recycled gas only.

(2) If the analysis of the D2 gas concentration by GA1 44 is below process specifications (e.g., the treatment gas contains a 2% deuterium-in-nitrogen mixture) but is otherwise usable (e.g., it is not contaminated) if enriched by fresh D2 gas, then valves F 36, J 20 and K 22 are opened and flow controllers MFC1 48 and MFC2 50 are proportioned by the process controller 43 to provide a gas mixture which is within process specifications.

(3) If the analysis of the D2 gas concentration by GA1 44 is below process specifications and unusable even when enriched by fresh D2 gas (e.g., the D2 levels are extremely low or the recycled gas is contaminated), then valve F 36 closes, and valves K 22 and G 38 are opened to fill the chamber entirely with fresh D2 gas from the supply stream 39.

After the treatment chamber 15 is filled to operating pressure, such as 15 psig, as determined by a pressure transmitter (not illustrated) within the fiber treatment chamber 15, valves K 22 and J 20 are closed. As previously noted, the system 10 may be implemented with additional treatment chambers. Therefore, one or more input pipelines 74 and 75 may be used to fill additional chambers with fresh and/or recycled gas.

After the optical fiber within the treatment chamber 15 is exposed to the treatment gas for a desired period of time, the gas recycle process is initiated by pumping the fiber treatment chamber 15 down to near atmospheric pressure using a gas compressor 52. To effect this, valves X 28, Y 30 and A 24 are closed and valves Z 33 and C 26 are opened. The gas exits the chamber 15 and is supplied to the compressor 52, which is a conventional gas compressor operable to discharge gas at a pressure of 80 psig. Gas leaving the compressor 52 passes through a heat exchanger 68, which cools the compressed gas.

According to one aspect of the invention, a sample gas stream is sent to GA2 58, which analyzes the constitution of the gas. GA2 58 operates like GA1 44 and is in communication with the process controller 43. More specifically, GA2 58 measures the concentration of the sample of compressed treatment gas to determine if the compressed treatment gas has been contaminated and is thus unsuitable for use to treat additional optical fiber. Therefore, GA2 58 serves to identify unusable or contaminated treatment gas prior to it being stored in the recycled gas storage tank 47. GA2 58 reports the concentration of the gas, and thus the level of any contaminants, to the process controller 43. The process controller 43 compares the concentration of the sample gas stream analyzed by GA2 58 to acceptable, predefined treatment gas concentration values. If the process controller 43 determines that the concentration level of the sample is too low, valve D 60 is closed to prevent contaminated gas from entering the storage tank 47 and valve E 62 is opened to expel contaminated gas out a vent 64 until desired concentration levels are achieved or until all of the unacceptable gas is expelled. Although the use of GA2 58 is preferred because it eliminates contaminated gas from being stored within the recycled gas storage tank 47, it will be appreciated by those of ordinary skill in the art that the system 10 may be implemented without analyzing the concentration levels prior to storing treatment gas in the recycled gas storage tank 47. In such a scenario, a vent should nevertheless exist in the system (e.g., between the recycled gas storage tank 47 and the fiber treatment chamber) to dispose of any treatment gas identified by a gas analyzer as unacceptable or contaminated.

After the gas compressor 52 has evacuated the fiber treatment chamber 15 down to near atmospheric pressure, a vacuum stage is initiated in order to reclaim any remaining treatment gas in the chamber 15. Again, where system 10 is implemented using several fiber treatment chambers, the vacuum stage may be applied to additional chambers. Likewise, input line 19 represents one or more output lines similar to output line 17 with valve Z33. To accomplish this, valve C 26 is closed, and valves A 24 and B 56 are opened. VP2 54 then expels the remaining treatment gas within the chamber 15 out the chamber's output pipeline 17, through a heat exchanger 66, and to the gas compressor 52. Gas leaving the compressor 52 passes through another heat exchanger 68. Like the process described above, a gas sample is analyzed by GA2 58, which measures the concentration of the compressed treatment gas and reports the concentration of the gas to the process controller 43. If the process controller determines that the concentration level is too low, valve D 60 is closed and valve E 62 is opened to expel contaminated gas out a vent 64 until desired concentration levels are achieved.

The recovered gas which is not vented enters the recycled gas storage tank 47 where it is stored under pressure for future reuse to treat additional optical fiber. Once the chamber 15 is pumped down using VP2 54, the vacuum on the chamber 15 is released to facilitate opening the chamber 15 to remove the treated fiber. The vacuum is released by closing valves Z 33 and Y 30 and opening valve X 28. After the fiber is removed a new batch of optical fiber may be placed in the chamber 15 and the chamber 15 is sealed. The process repeats itself when the stored recycle treatment gas is released from the storage tank 47 into the chamber 15 until the desired chamber pressure is reached.

Although the above system is a preferred embodiment of the present invention, it will be appreciated that additional configurations are also possible. Therefore, the system may comprise additional elements to achieve the same or similar function as described herein. Additionally, it will be appreciated that one or more electrical controls comprising software and/or hardware may be used to control the process described above, as is well known in the art. For instance, the process controller 43 or a similar control device may be used to control each of the elements within the system 10 of FIG. 1, including, e.g., the valves, compressor, vacuums, and mass flow controllers, thereby automating the system 10. Thus, each of the steps described above may be effected by computer software and/or hardware in communication with the system 10 components. This allows the system 10 to operate routinely without an operator physically effecting the opening and closing of valves and the like. Additionally, according to one aspect of the invention the system is fully automated between the steps of loading of optical fiber within the chamber and the removal of the treated fiber from the chamber. However, a system operator may override the automated system control.

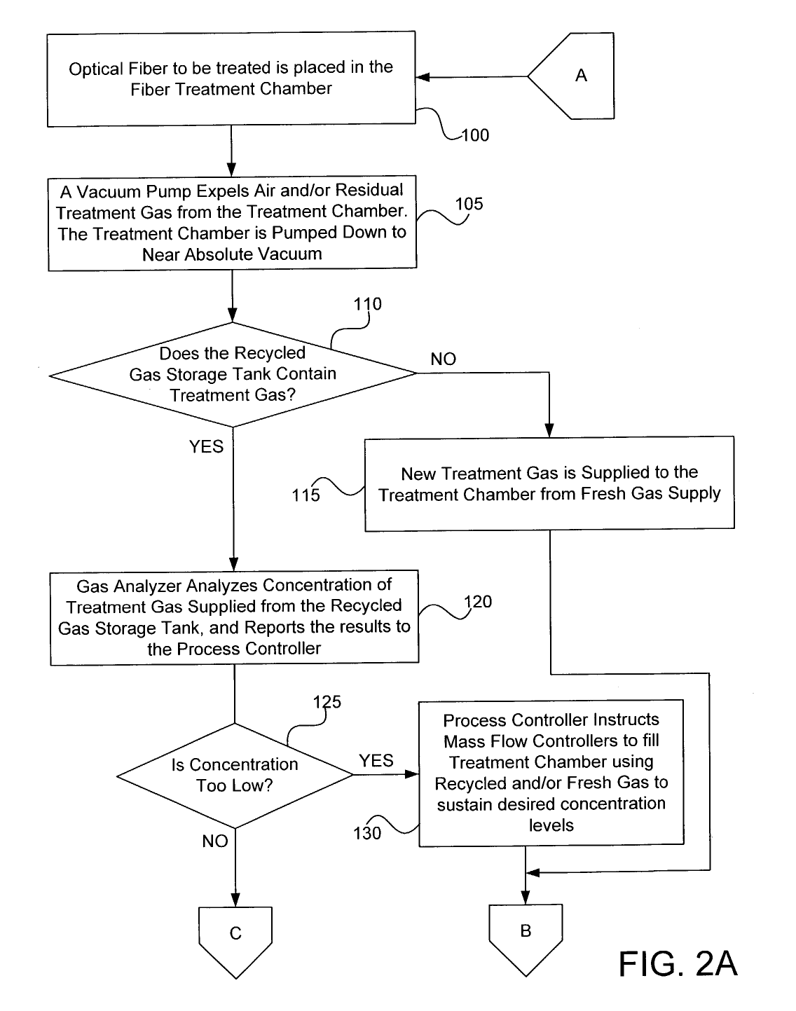

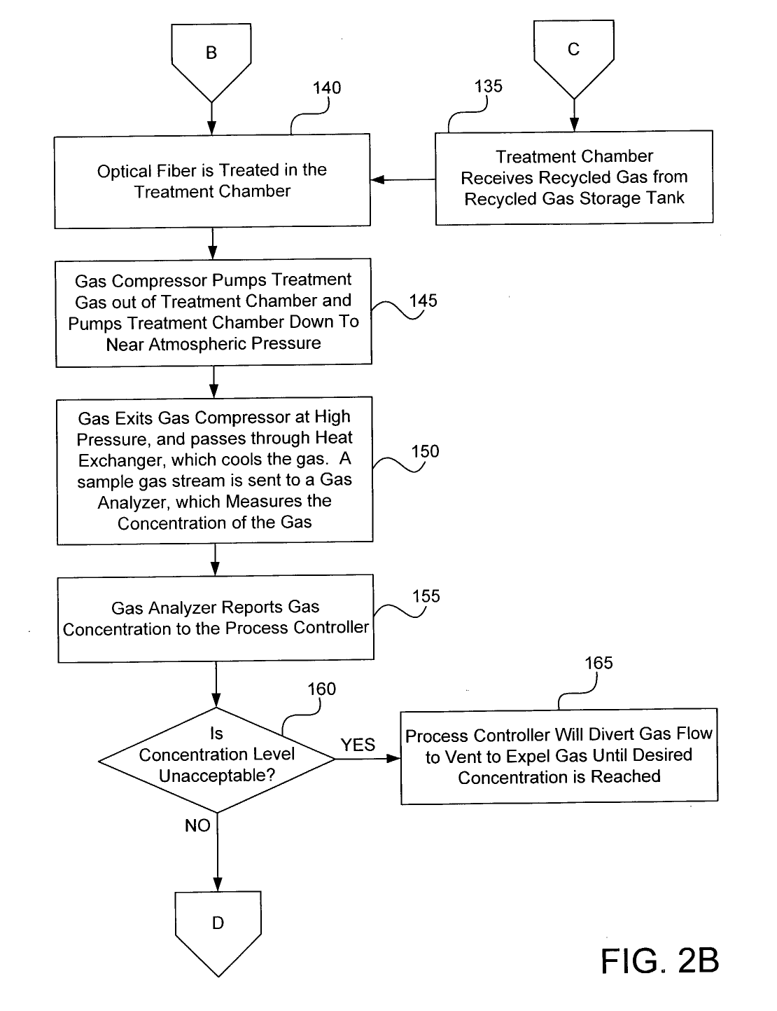

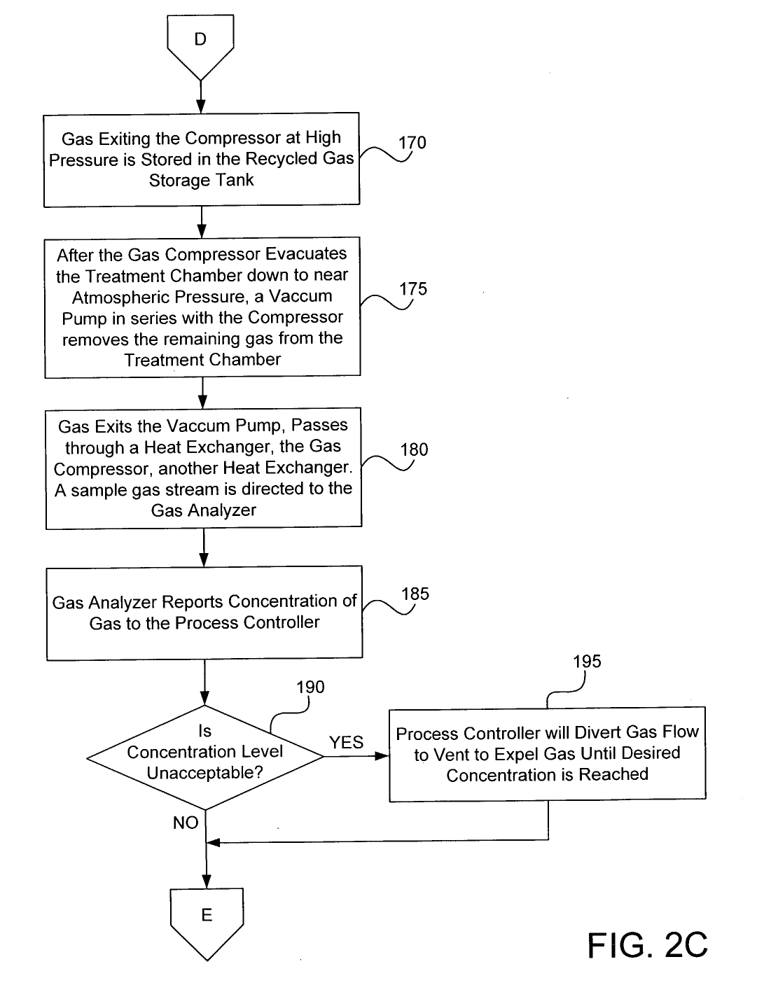

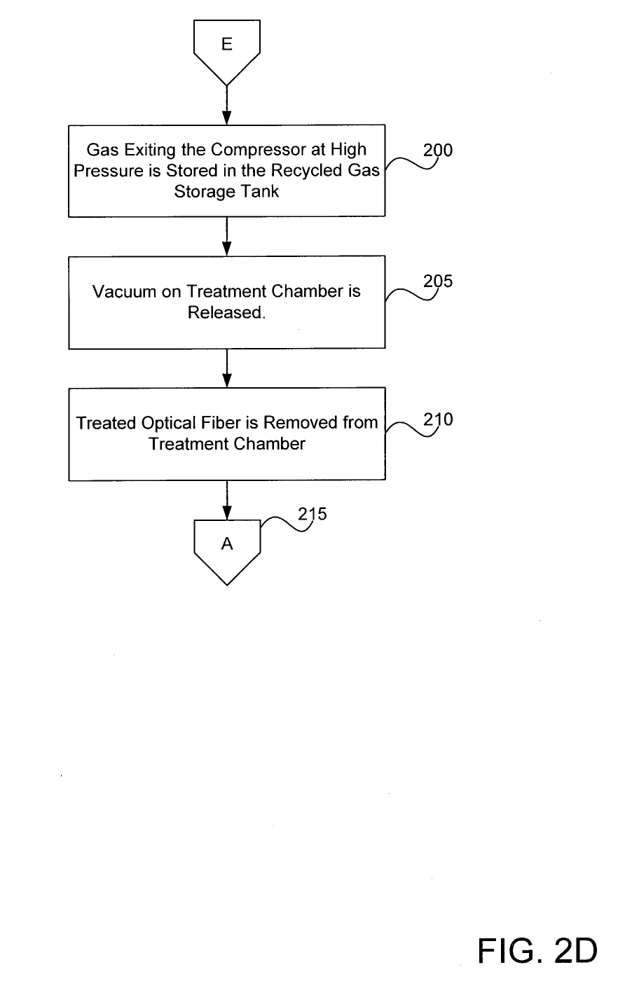

FIGS. 2A, 2B, 2C and 2D show a block diagram flow chart illustrating a method for treating optical fiber using recycled gas, according to one embodiment of the present invention. As illustrated in FIG. 2A, optical fiber to be treated is placed and sealed in the fiber treatment chamber (block 100). A vacuum pump then expels the air and/or residual treatment gas from the treatment chamber, and pumps the treatment chamber down to near an absolute vacuum (block 105). After the treatment chamber is pumped down to near an absolute vacuum, the treatment chamber is prepared to receive the treatment gas. If the recycled gas storage tank does not contain sufficient treatment gas, e.g., 25 psig, (block 110), then new treatment gas is supplied to the treatment chamber from a fresh gas supply (block 115). Alternatively, if the recycled gas storage tank contains treatment gas, a gas analyzer receives a sample gas from the recycled gas storage tank and analyzes the concentration of the treatment gas (block 120). For example, where a 3-5% deuterium-in-nitrogen mixture is used as the treatment gas, the gas analyzer is operable to determine the respective percentages of deuterium and nitrogen in the treatment gas. Once this analysis is made, the gas analyzer reports the results to a process controller (block 120). The process controller also receives a measurement indicating the pressure level of treatment gas in the storage tank (block 120). The process controller, which has been programmed with the acceptable levels or ranges of concentration of the treatment gas, or individual components within the treatment gas, determines whether the measured levels reported by the gas analyzer are sufficient (block 125). The process controller also determines if the pressure level of stored treatment gas is sufficient to supply the treatment chamber (block 125). If concentration level of treatment gas is low, but adequate if supplemented by fresh gas, the process controller will instruct one or more mass flow controllers to fill the treatment chamber using the recycled gas in combination with fresh gas to bring concentration levels within an acceptable range (block 130). If the concentration levels are too low, and inadequate even if supplemented by fresh gas, the process controller will shut off the gas flow from the storage tank and will provide fresh D2 gas to the treatment chamber (block 130). If the concentration levels are acceptable (block 125), the treatment chamber receives the treatment gas from the recycled gas storage tank (block 135), as illustrated in FIG. 2B.

After the treatment chamber is filled by treatment gas at a desired temperature and pressure and the optical fiber is treated (block 140) for a desired period of time, a gas compressor pumps the treatment gas out of the treatment chamber (block 145). The compressor is preferably operable to pump the treatment chamber down to near atmospheric pressure (block 145). The now used treatment gas exits the gas compressor at high pressure, e.g., 80 psig, and passes through one or more heat exchangers, which cool the compressed gas (block 150). A sample gas stream is also sent to a gas analyzer, which analyzes the concentration of the gas (block 150) in a similar manner as described with respect to block 120, above. The gas analyzer reports the constituents of the gas, or the concentration of one or more elements within the gas, to the process controller (block 155).

If the concentration of desired treatment gas components are too low, the process controller may instruct a vent to open to expel treatment gas until desired concentration levels are achieved or all of the gas is vented (block 165). If the concentration levels are acceptable, or are achieved through venting or expelling gas, the compressed gas is stored in the recycled gas storage tank (block 170). After the gas compressor evacuates the treatment chamber down to near atmospheric pressure, a vacuum is applied to the treatment chamber to reclaim any remaining gas in the chamber (block 175). According to one aspect of the invention, the vacuum pump in series with the compressor evacuates the chamber down to near an absolute vacuum. After the gas exits the vacuum, it passes through one or more heat exchangers, the gas compressor, and a sample is sent to a gas analyzer (block 180). The process described above with respect to blocks 155, 160, 165 and 170 is then repeated (blocks 185, 190, 195 and 200). After the gas is stored in the recycled gas storage tank the vacuum on the treatment chamber is released (block 205) and the treated optical fiber is removed from the treatment chamber (block 205). The process may then repeat itself (block 215) when new optical fiber to be treated is placed in the fiber treatment chamber.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A method of recycling gas used to treat optical fiber in a sealed chamber, comprising:
exposing the optical fiber within the sealed chamber to a treatment gas supplied by a storage tank;
evacuating the treatment gas from the sealed chamber; and
storing the treatment gas in the storage tank for exposure to a subsequent optical fiber.

2. The method of claim 1, wherein the step of storing the treatment gas comprises the step of storing the treatment gas at high pressure in the storage tank.

3. The method of claim 1, wherein the treatment gas comprises deuterium.

4. The method of claim 1, further comprising the steps of removing said optical fiber from the sealed chamber and placing said subsequent optical fiber in said sealed chamber.

5. The method of claim 4, further comprising the step of evacuating air in the sealed chamber after the subsequent optical fiber is placed in the sealed chamber.

6. The method of claim 5, further comprising the step of filling the sealed chamber containing said subsequent optical fiber with the treatment gas.

7. The method of claim 5, further comprising the step of adding fresh gas to the treatment gas prior to the step of filling the sealed chamber containing said subsequent optical fiber with the treatment gas.

8. A method of treating optical fiber using treatment gas, comprising:
exposing a first optical fiber to treatment gas, storing said treatment gas; and
exposing a subsequent optical fiber to the stored treatment gas.

9. The method of claim 8, further comprising the step of compressing said treatment gas prior to storing said treatment gas.

10. The method of claim 8, further comprising the step of placing said first optical fiber and said subsequent optical fiber in a fiber treatment chamber prior to exposing said first optical fiber and said subsequent optical fiber to the treatment gas.

11. The method of claim 10, further comprising the step of pumping down said fiber treatment chamber to remove said treatment gas.

12. The method of claim 8, further comprising the step of analyzing said treatment gas prior to it being exposed to the subsequent optical fiber.

13. The method of claim 12, further comprising the step of supplementing said treatment gas with fresh treatment gas to maintain desired concentration levels of said treatment gas, prior to the step of exposing a subsequent optical fiber to the treatment gas.

14. The method of claim 8, further comprising repeating the steps of storing said treatment gas and exposing a subsequent optical fiber to the stored treatment gas.

15. A system for treating optical fiber using treatment gas, comprising:
a fiber treatment chamber, into which optical fiber is placed and releasably sealed, wherein the fiber treatment chamber is operable to receive treatment gas to which the optical fiber placed therein is exposed; and
a storage tank, operable to store the treatment gas subsequent to it being exposed to the optical fiber, wherein the storage tank is further operable to supply said stored treatment gas to the fiber treatment chamber for later exposure to additional optical fiber.

16. The system of claim 15, further comprising at least one compressor, wherein the at least one compressor is operable to draw the treatment gas from the fiber treatment chamber and supply said treatment gas to the storage tank.

17. The system of claim 15, further comprising at least one pump operable to draw the treatment gas from the fiber treatment chamber subsequent to it being exposed to the optical fiber.

18. The system of claim 15, further comprising at least one gas analyzer to analyze the treatment gas prior to its later exposure to additional optical fiber.

19. The system of claim 18, further comprising a process controller in communication with the at least one gas analyzer, wherein said process controller is operable to adjust the quantity of said stored treatment gas supplied to the fiber treatment chamber for exposure to additional optical fiber.

20. The system of claim 19, wherein said process controller is further operable to adjust an input supply of fresh treatment gas supplied, with the stored treatment gas, to the fiber treatment chamber for exposure to additional optical fiber.
